(19) United States
(12) Patent Application Publication
(10) Pub. No.: US 2002/0107889 A1
(43) Pub. Date: Aug. 8, 2002

(54) Markup language routing and administration

(75) Inventors: Christopher Stone, Harvard, MA (US); Carlos Muchiutti, Clinton, MA (US)

Correspondence Address: LAHIVE & COCKFIELD, 28 STATE STREET, BOSTON, MA, 02109, US

(73) Assignee: Tilion Corporation

(21) Appl. No.: 09/779,807

(22) Filed: Feb. 8, 2001

(51) Int. Cl. G06F 7/00

(52) U.S. Cl. 707/513; 707/100

(57) ABSTRACT

A method and apparatus for management of business transactions in a computer network are disclosed. A modified hierarchical database that includes document type definition objects that represents a DTD or DTD locations are utilized. Additional objects are included to control access to data content and to provide customized analytic formats for a report generator. The hierarchical database is able to interact with one or more nodes in the communication network to transparently provide the necessary content routing without additional user input beyond the initial user setup.

### TECHNICAL FIELD

The present invention relates generally to data processing and more particularly to a method and apparatus for managing data in a communication network through the use of administration objects and document type definition objects in a hierarchical directory services database.

### BACKGROUND OF THE INVENTION

The exchange of data between two entities over a communication network, such as the Internet, is cumbersome because most business entities operate a proprietary and closed system for collecting and distributing business data. Consequently, the exchange of business data via a communication network between two business entities requires each entity to install a data filter or interpreter that converts the data format of each entity into data formats that are compatible with the receiving entity. Moreover, the sensitivity of the business data being exchanged requires the exchange to be secure.

One response to the above identified issues of exchanging business data via a communication network is the establishment of the standardized data format known as the Electronic Data Interchange (EDI). EDI allows business entities to exchange business data over a communication network without the need for data filters or interpreters. However, use of the EDI data format requires each business entity to operate an EDI compatible system. Often, an EDI compatible system requires specialized software, a dedicated communication link, and a modem. In addition, some business entities require trading partners to use specific hardware and software to ensure data compatibility with legacy systems, such as legacy databases. As a result, smaller, less sophisticated business entities are unable to benefit from the exchange of electronic business data due to the complexity and cost of operating and supporting multiple systems communication network.

Another response to the above identified issues of exchanging business data via a communication network is the creation of a Virtual Private Network (VPN). A VPN is a private data network that utilizes the public telephone communication infrastructure, but maintains user privacy through the use of a tunneling protocol, such as the point to point tunneling protocol (PPTP). VPN seeks to provide business entities the same capabilities as an EDI system, but at a much lower cost by using the shared public infrastructure rather than a private infrastructure. The use of a VPN involves encrypting the business data before sending the data through the public network and decrypting the data at the receiving business entity. The software for realizing a VPN is typically installed as part of a firewall for a business entity. However, a VPN does not directly address the issue of data compatibility between two or more business entities having propriety database schemas, operating systems, or the like. In these instances, filters and/or interpreters are still necessary to create a compatible data format before data is encrypted and sent from a transmitting business entity to a receiving business entity for decryption.

Moreover, both an EDI and a VPN suffer the drawback that the transmitting entity relinquishes data access control and security to the receiving entity. As a result of the above-described problems, the sharing of crucial business data amongst multiple business entities is a heavy burden.

### SUMMARY OF THE INVENTION

The present invention addresses the above-identified problems associated with conventional electronic business transactions. In particular, the present invention provides both a method and an apparatus for managing access to self describing data and for controlling its distribution in a communication network using a directory having one or more objects organized in a hierarchical manner. In one embodiment of the present invention, user access information defines the transmitted content a network user may access. The user access information also defines a format for presenting the accessed content. The user access information is encapsulated into an object of a directory. In addition, attributes of the network user, such as physical location and user preferences (i.e. data content the user wishes to view based on time, date, or dollar amount) are encapsulated into an object in the directory. Additional network user attributes, such as the user's name, I.D., and password, are also encapsulated into an object in the directory.

The storing of the objects in the directory enables a user with a valid I.D. and password to electronically access business data from a trading partner, a strategic alliance, or a supplier to perform data analytics on the desired content. Further, the directory enables a communication network to receive documents in a markup language, such as the extensible markup language (XML), from a first network user for selected distribution to other network users. As such, the data formulas that define the received data schema are encapsulated into objects and stored in a hierarchical manner in the directory. Hence, the communication network utilizes the data formula objects to validate received markup language documents and to locate content in a received markup language document a business partner or customer may access.

In accordance with another aspect of the present invention, an apparatus is provided in the communication network. The network has a directory that controls access to data stored in the network. User attributes, such as a user I.D. and password are encapsulated into objects and stored in the directory in a hierarchical manner. When the apparatus receives data from a network user, the apparatus identifies the originator and the recipient from the submitted data. The originator and the recipient identified in the received data operate to define the owner of the data. Then, based on the defined owner of the data, a directory lookup is performed to obtain a distribution for the data. The directory lookup examines the attributes of the data owner that are encapsulated into objects that define which content is distributed and further defines the specific content a particular network user may receive. Once the content distribution map is determined, the apparatus selects the defined content from the received document and routes the selected content to the identified network users. The data owner attributes that are encapsulated into an object are defined by the originator and the recipient (the “owner”) of the document and provide the properties necessary to control content access for an identified business entity, a business entity location, a user, a group of users, or the like.

In accordance with a further aspect of the present invention, a computer readable medium holds computer executable instructions for performing a method in a distributed system having a directory containing a plurality of objects organized in a hierarchical manner. In accordance with the method, user access privileges are encapsulated into an object located in the directory. For each user in the distributed system, an associated object defines the data content access privileges. In addition, attributes of a user's preferred analytic output format are also encapsulated into an object of the directory to define one or more unique data formats for each user of the distributed system. As a result, a default analytic output format may be created for each distributed system user to eliminate the need for a user to continuously format analytic data. Consequently, the distributed system utilizes the encapsulated data access information and the encapsulated user characteristics in conjunction with header information in the desired data to select specific data content from one or more electronic business documents and forward the selected content to the user for data analysis.

### BRIEF DESCRIPTION OF THE DRAWINGS

An illustrative embodiment of the present invention will be described below relative to the following drawings.

FIG. 1 depicts a block diagram of a communication network that is suitable for practicing the illustrative embodiment of the present invention.

FIG. 2 depicts a schematic diagram of the hierarchical structure utilized by the illustrative embodiment of the present invention.

FIG. 3 is a flow diagram depicting the management of data in the communication network in accordance with the illustrative embodiment of the present invention.

FIG. 4 is a flow diagram depicting the steps involved in accessing user report preferences.

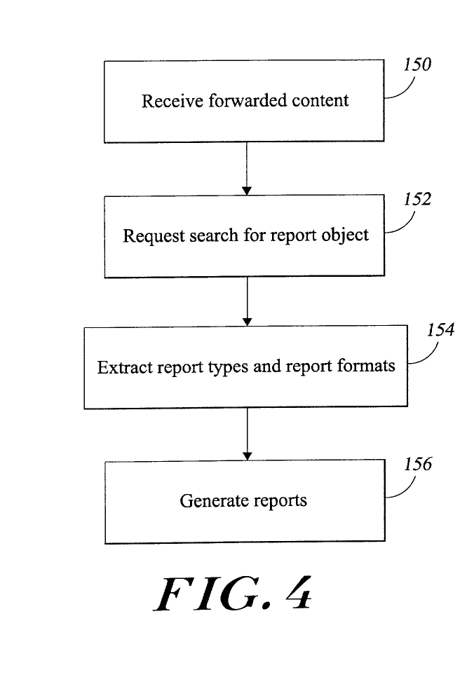

### DETAILED DESCRIPTION OF THE INVENTION

The illustrative embodiment relates to a method and apparatus that utilize a directory having one or more objects organized in a hierarchical manner for managing electronic business data via a network, such as the Internet, an extranet or even an intranet. The directory provides the necessary framework to manage and control electronic business data. The business data is formatted in a markup language format such as the extensible markup language (XML) format. The directory allows a data owner to define and encapsulate a set of rules into an object of the directory, where the rules specify which tags can appear in the data document and how the tags should appear in the data document. In this manner, the data owner may provide a document content framework or schema that supports the data owner's internal data needs within its legacy information system that also supports the external data needs of business partners or suppliers on their legacy information systems without the need for data filters, interpreters, EDI formatting, or the use of VPN's.

In the illustrative embodiment, the directory extends the base directory schema provided by Novell's NetWare Directory Services (NDS) version 8.x to accommodate an inventive set of object class definitions. Novell NetWare Directory Services (NDS) version 8.x is a product of Novell, Incorporated located in Provo, Utah. The inventive set of object class definitions includes at least three new classes, a document type definition (DTD) class, a business rule class, and a report class. The DTD class stores one or more strings, each of which may contain either a DTD or an identifier such as a uniform resource identifier (URI) to indicate the DTD location. The business rule class stores one or more strings as well. The strings in the business rule class define the data owner's rules for processing received XML documents, including data routing rules and user content permission rules. The report class also stores one or more strings, which contain user preferences regarding analytic output formats for each report generated.

In order to clarify the discussion below, it is helpful to first define a few terms.

An “originator” identifies the entity that initiated the transfer of data between one or more recipients, such as the business entity that transmits a purchase order. The originator is identified in a header or wrapper placed around every markup language document. There is only one “originator” for each markup language document.

A “recipient” identifies a business entity with which the “originator” is exchanging a transaction, such as the business entity receiving a purchase order. The recipient is identified in a header or wrapper placed around every markup language document.

An “owner” is the entity that has legal ownership of the data in the markup language document. An owner is defined as the group consisting of the “originator” and the “recipient(s)”.

A “destination” defines a business entity location where the transaction data is routed the communication network to perform data analytics. A destination location may be an originating business entity, or a recipient business entity, or a third party to the business transaction, such as a top tier supplier or the operator or the communication network. If the originating or the recipient business entity do not have analytic capabilities, they are not considered a destination.

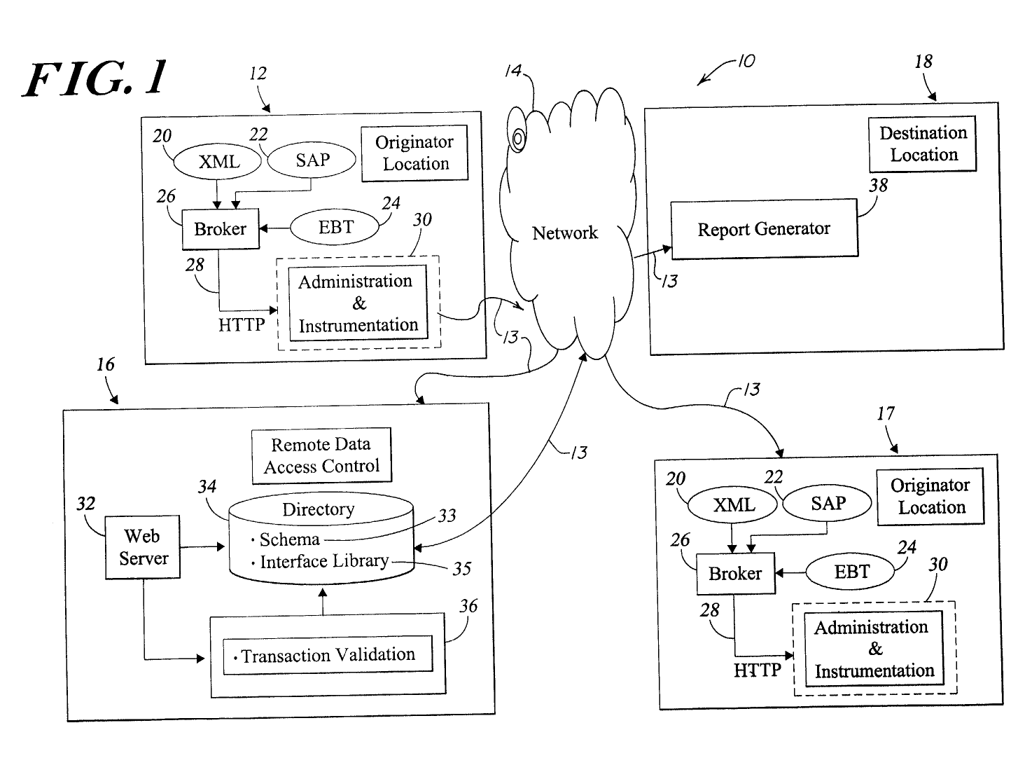

FIG. 1 depicts an exemplary communication network 10 suitable for practicing the illustrative embodiment of the present invention. The communication network 10 includes an originator location 12 in communication, via the network 14, with the remote data access control facility 16. The originator location 12 is the business entity that initiates the data transfer directly to the recipient location 17. The data transfer may be a purchase order, manufacturing metrics, or the like. The remote data access control facility 16 receives a copy of the data transmitted, in an XML format, from the originator location 12 and manages further distribution of the data by controlling the routing and access of the data by other network users. The destination location 18 is the location where analytics are performed on the originator's and the recipient's data. The destination location 18 may be a location within the originator location 12, a location within the recipient location 17, a location within the remote data access control facility 16, or locations within the originator location 12 the recipient location 17 and within the remote data access control facility 16, or a location of a third party, such as a top tier supplier. The remote data access control facility 16 is in communication, via the network 14, with the destination location 18.

One skilled in the art will recognize that other communication mediums, such as the Internet, a virtual private network (VPN), a Local Area Network (LAN), dedicated lines, wireless communication links, or the like, may be utilized for the network 14 in whole or in part. Nevertheless, those skilled in the art will recognize that communication network 10 may have significantly more originator locations 12, recipient locations 17, and destination locations 18 than depicted in FIG. 1. The use of the network 14 as the communication medium linking the originator location 12, the remote data access control facility 16, the recipient location 17, and the destination location 18 provides the benefit of near ubiquitous access to trading partners, strategic alliances, or the like.

The originator location 12 and the recipient location 17 are responsible for interfacing with legacy business systems and translating the legacy business data format into a markup language format such as XML for transmission to the remote data access control facility 16. The originator location 12 and the recipient location 17 both include an object request broker 26 and an administration and instrumentation module 30. One skilled in the art will recognize that the originator location 12 and the recipient location 17 may reverse rolls. That is, the recipient location 17 may be considered an originator location when transmitting data and the originator location 12 may be considered a recipient location when receiving data. Hence, the object broker 26 and the administration and instrumentation module 30 are active only when a location acts as an originator location. Likewise, the object broker 26 and the administration and instrumentation module 30 are bypassed when a location acts as a recipient location.

The object request broker 26 is included in the originator location 12 for translating business data from one or more data formats such as, a legacy specific XML format 20, an SAP format 22, or an electronic business transaction format 24 such as EDI into a markup language format. Upon translation of the business data into a markup language format, the object request broker 26 packages the translated data into the hypertext transfer protocol (HTTP) and forwards the data to the administration and instrumentation module 30 for further processing. The object request broker 26 and the administration and instrumentation module 30 communicate via the interconnection 28. The interconnection 28 may be a computer bus, an Ethernet cable, a twisted pair, a fiber optic cable, or the like. One skilled in the art will recognize that the object request broker 26 may be an active broker in that it automatically polls the legacy business systems for data or the broker may be a passive broker that waits or listens for business data from the legacy business systems.

The administration and instrumentation module 30 is able to parse the received markup language package from the object request broker 26 to assure a well formed markup language document. Further, once the administration and instrumentation module 30 completes the parsing of the markup language document, the administration and instrumentation module 30 utilizes the communication link 13 to establish a secure communication link, via the network 14, with the remote data access control facility 16. Communication link 13 may be a fiber optic cable, a TI line, a T3 line, or like.

The secure communication link that the administration and instrumentation module 30 establishes may include a secure protocol such as the Secure Sockets Layer (SSL), the Public Key Infrastructure (PKI), or other methods of encryption or security utilized to transmit data in a secure fashion via the Internet. Once the secure link is established with the remote data access control facility 16, the originator location 12 forwards the markup language data document in the secure protocol to the remote data access control facility 16. The markup language document includes a message header that indicates to the transaction validation module 36 the originator of the markup language document, and the intended recipient of the markup language document.

The originator location 12 provides the benefit of creating a homogenous data format for distribution, storage, and analysis on a communications medium that provides near ubiquitous access to the homogenous data. Moreover, the originator location 12 provides an open architecture that is capable of interfacing with legacy data structures and formats without the need for additional computing systems. One skilled in the art will appreciate that the above described interaction of processing elements is applicable to the recipient location 17 when the recipient location 17 is in the transmit or origination mode.

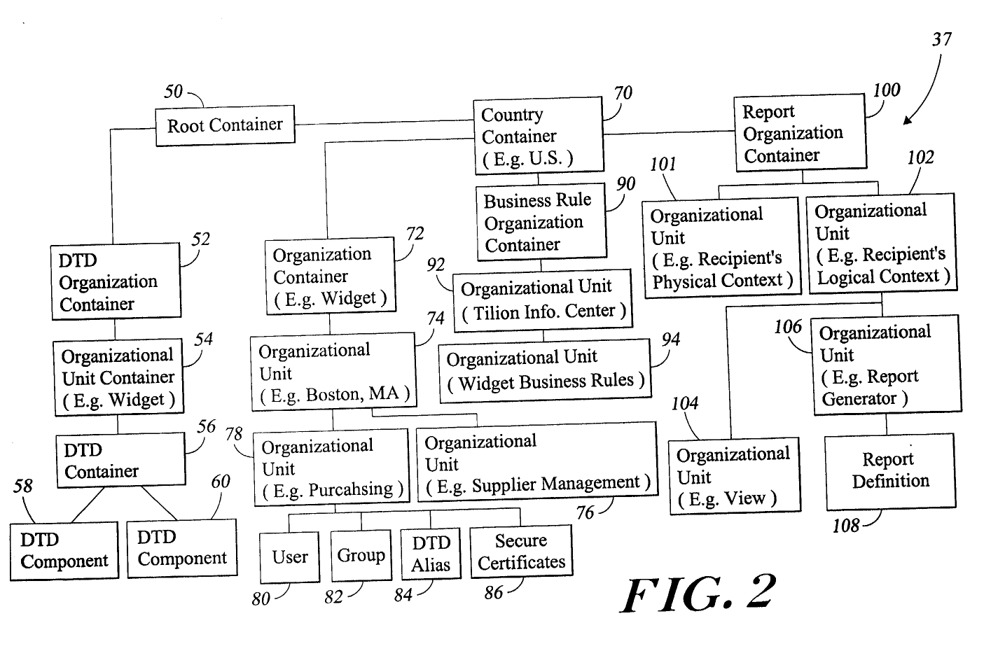

The remote data access control facility 16 includes at least one web server 32 to which is coupled the directory 34 and the transaction validation mechanism 36. The directory 34 also includes an interface library 35 that provides access to the base schema 33 of the directory 34, from the web server 32, the transaction validation mechanism 36, or the report generator 38 in order to determine access authorization and routing information for data transmitted by the originator location 12. The base schema 33 will be discussed in detail below in conjunction with FIG. 2. The interface library 35 includes a cache and in some embodiments, includes tables or commands that are read by the base schema 33 to locate an object. Thus, the interface library 35 may be used to hold frequently requested objects or utilized to define available attributes and objects.

To route and control access of data received from a originator location 12, the web server 32 utilizes the transaction validation mechanism 36 to first decode the digital certificate attached to the markup language document and then extract content routing data from the header of the received data. The translation validation mechanism 36 obtains the Certificate Authority's (CA) public key to decode the digital certificate from an object located in the directory 34.

The destination location 18 includes a report generator 38 that interfaces with the remote data access control facility 16 via the network 14. The destination location 18 utilizes the communication link 13 to access the network 14 for communication with the remote data access control facility 16. The report generator 38 provides the destination location 18 with the capability to perform preferred data analytics on the data packaged by the originator location 12. The report generator 38 is capable of performing data analytics while the data is in a markup language format such as XML, and publish the analytic results in a pre-defined format such as, the hypertext markup language (HTML) format, or the Microsoft Excel format, or the like to.

The report generator 38 is also in secure communication with the remote data access control facility 16 in order to protect the confidential nature of the data being transmitted via the network 14. The destination location 18 provides the benefit of performing data analytics in a manner that a destination location 18 desires, or requires, and is accustom to viewing and interpreting. Further, the destination location 18 also interfaces with the legacy business systems located at the destination location 18 to provide additional data processing or data distribution.

FIG. 2 is a hierarchical tree that depicts the inventive extended schema 37 of the base schema 33 in more detail. The extended schema 37 conforms to the structure of the base schema 33, which will be discussed in more detail below. That is, each attribute syntax in the extended schema 37 is specified by an attribute syntax name and the kind and/or range of values that can be assigned to the attributes of the given syntax type. Thus, attribute syntaxes correspond to data such as, an integer, a string, a character, or the like.

One skilled in the art will appreciate that each attribute in the extended schema 37 has an attribute name that identifies the attribute and an attribute syntax type that limits the values that are assumed by the attribute. For instance, the extended schema 37 includes an attribute of syntax type character having the name “DTD” which specifies a Document Type Definition for a given markup language document. Moreover, each attribute may also have associated with it one or more of the following flags: non-removable, hidden, public read, read only, single value, sized, and string. One skilled in the art will recognize the meanings of these flags and their appropriate use.

Each object class in the extended schema 37 also has certain information associated with it. Each class has a name which identifies the class, a set of upper classes that identifies the other classes from which this class inherits attributes, and a set of containing classes that identify the classes permitted to contain instances of this class. Although the topic of class inheritance, containment, and instantiation are familiar to those skilled in the art, their use in connection with a data type definition (DTD) object class or classes according the present invention is novel.

Each object class also has a container flag and an effective flag. The container flag indicates whether the class is a container class, that is, whether it is capable of containing instances of other classes. The effective flag indicates whether instances of the class can be defined. Non-effective classes are used only to define attributes that can be inherited by other classes, whereas effective classes are used to define inheritance attributes, to define instances, or define both.

In addition, each object class groups together certain attributes. For example, the naming attributes of a class are those attributes that can be used in an instance of the class. Further, the mandatory attributes of a class are those attributes that must exist in each valid instance of the class and/or become mandatory attributes of classes that inherit from the class. The optional attributes of a class are those attributes that may, but need not, exist in each valid instance of the class. Optional attributes of a parent class become optional attributes of child class that inherits form the parent class, unless the attributes are mandatory in some other parent class from which the child inherits, in which case they are also mandatory in the child.

As one skilled in the art will recognize, the extended schema 37 can be traversed by means of simple search commands, and full browsing capabilities are provided by using wild cards and placeholders. The extended schema 37 is designed so that objects are returned as the result of searches with the type of object which is returned being determined by the implementation of the portion of the directory which returns the object. Examples of objects which can be returned from the extended schema 37 include DTD object 58 or DTD object 60 that define the declaration and rules or a location for elements in the attributes of a received markup language document from the originator location 12. In addition, other objects such as secure certificates 86 may be utilized to authenticate the markup language document from the originator location 12 and to provide the remote data access control facility 16 with the means to encode a reply.

The extended schema 37 is organized as a single hierarchical tree as depicted in FIG. 2. One skilled in the art will recognize that the tree configuration shown in FIG. 2 is for illustrative purposes only and that an actual tree configuration can differ significantly from the illustrated configuration without departing from the scope and principles of the present invention. The ultimate root of the extended schema 37 is the root object 50 of the directory 34. The extended schema tree shown in FIG. 2, may include methods written specifically for an associated service such as, routing specific content to one or more destination locations 18, formatting an analytics format based on user preferences, or object aliases such as DTD alias 84, which points to the appropriate DTD component to provide information hiding and ease of use.

The extended schema 37 extends directly from the root container 50 of the directory 34. The extensions to the base classes of directory 34 include the DTD organization container 52, the BusinessRule organization container 90, and the Report organization container 100. One skilled in the art will recognize that prior to the present invention, the base schema 33 did not support definition type definition (DTD) type objects.

The DTD organization container 52 is a first level DTD organization object that contains the containers for each organizational unit having a DTD. Such an organizational unit is shown as organizational unit container 54 for the hypothetical corporation “Widget.” One skilled in the art will recognize that the use of hypothetical corporations is meant to assist in the disclosure the inventive aspects of the present invention without detracting from the invention's intended scope and purpose. Branching from the organizational unit 54 is the organization's DTD container 56, which in turn references the DTD component 58 and the DTD component 60.

The DTD container 56 represents a composite DTD object that comprises a DTD container class object that contains one or more DTD component class objects. In this manner DTD components are grouped such that references to a containing DTD return all the contained DTD's as well as the container. For example, if the DTD container 56 contains internal references to the DTD component 58 and the DTD component 60, the request for the DTD container 56 returns the DTD component 58 and the DTD components 60 as a collection. One skilled in the art will recognize that the extended schema 37 may also contain non-composite DTD containers, that is, a DTD container that contains no nested references to other DTD objects.

Because a markup language format such as XML is self describing, the data structure of the markup language document does not need to be agreed upon prior to exchanging data in an XML format. As a result, each business entity may create or have a DTD created and placed in the directory 34 thus avoiding the need for data filters or translators. This benefit results in a data structure that fits the needs of all business alliances, because the associated DTD consists of a set of rules and declarations for the elements contained within the transmitted data structure. Consequently, the markup language data structure does not have to be compatible with one or more legacy relational database systems.

Branching from the country container 70 are three additional organization containers 72, 90, and 100. The organization container 72 defines an object class container for a business entity, for example the hypothetical corporation “Widget.” Branching from the organization container 72 is the organizational unit object 74 that further classifies and subdivides the objects in the organization, for example a geographical location such as Boston, Massachusetts. Branching from the organizational unit object 74 are additional organizational unit objects, such as the organizational unit object 78 and the organizational unit object 76 that further classify and subdivide the objects associated with the hypothetical entity “Widget” by departments, such as purchasing, supplier management, contracts administration, or the like. Branching from the organizational unit object 78 are non-container objects, such as the user object 80 that refers to authorized network users within the organizational unit object 78, the group object 82 that represents a combination of users grouped by a particular need, the DTD alias object 84 that points to a DTD container or DTD component in the extended schema 37, and the secure certificates object 86 which refers to the originator's public key and a variety of other identification information so that the transaction validation module 36 may retrieve the public key and validate the received markup language document. One skilled in the art will recognize that the organizational unit object 76 may also refer to similar non-container objects such as, user, group, DTD alias, secure certificates, or the like.

The organization container 72 provides the basic administration functions to control and manage access to the markup language content. As a result, a business entity may control the rights associated with adding DTD's, defining user authorization, defining which business alliances are granted administrator rights to define destination locations, and the like.

Branching from the BusinessRule organization container 90 is organizational unit container 92. The organizational unit container 92 is entity specific and contains the organizational unit objects for accessing the entity's business rules for processing received markup language documents. For example, the organizational unit 94 branches from the organizational unit container 92 to classify and subdivide which business entity department and which user, or group of users from that department such as purchasing, may view and access specific content of the received markup language document. Additional business objects may define whether or not transactions are permanently or temporarily stored within the directory, or stored within a relational database, based on transaction information such as, the originator location 12, the recipient location 17, the dollar value of the business transaction, or the like.

The Report organizational container 100 defines an object class that contains both the physical and logical context of the destination location 18. Branching from the Report organizational container 100 is the physical context organizational unit 101 and the logical context organizational unit 102 to further classify and subdivide the objects relating to the destination location 18. The physical context organization unit 101 defines the destination location 18, including hardware type, system software, address, and any other physical attributes of the destination location 18. Branching from the logical context organizational unit object 102 is the view organizational unit object 104 that defines a favorite reports and other activities that an organizational user at the destination location 18 can invoke. The view organizational unit object 104 may be user specific, location specific, or both.

Also branching from the logical context organizational unit object 102 is the report generator organizational unit object 106 that defines one or more report templates without any parameters. Branching from the report generator organizational unit object 106 is the report definition object 108 that inherits the default settings from the report generator organizational unit object 106 and further customizes the analytic reports as defined by user preferences. One skilled in the art will recognize that the report definition object 108 may contain one or more style sheets that define the viewing format of the analytic reports. Thus an analytics application may search the directory 34 using the interface library 35 to determine a user's preferred report type and the desired report format.

As a result, the directory 34 is able to manage and control access to electronic business transaction content and to select and route specific electronic business content to authorized users. Data owners may use the various objects of the directory 34 to grant user access to the electronic business transaction content through a combination of attributes such as date of transaction, type of transaction, and trading partners or alliances. Consequently, the data owner may further refine data access based on a specific data element, or documents that meet specific criteria such as total dollar value.

The inventive communications directory 34 interacts with both the originator location 12 and the destination location 18 in a transparent manner. The directory 34 allows the remote data access control facility 16 to receive and validate markup language documents from the originator location 12 using a DTD object and a secure certificate object. In addition, the directory 34 allows the remote data access control facility 16 to identify, select, and route selected content from the received markup language document to one or more destination locations 18 using a combination of originator and recipient information submitted with the markup language document and a Business Rules object defined by the data owner. In this manner, a destination location 18 that desires to perform and view analytics on specific markup language content at specific time intervals such as daily, weekly, biweekly, monthly, quarterly, or like, may automatically have the desired markup language content formatted into a preferred document format and automatically published at the destination location 18.

The directory 34 allows the owner of the data or the business transaction, to define the access rights, and the DTD to understand the data structure of the markup language document. Further, the originator and the recipient define the markup language content to be viewed by the destination location 18, such as all transactions above or below a specific dollar amount. This allows the data owner to retain substantially more control over the data at the destination location 18.

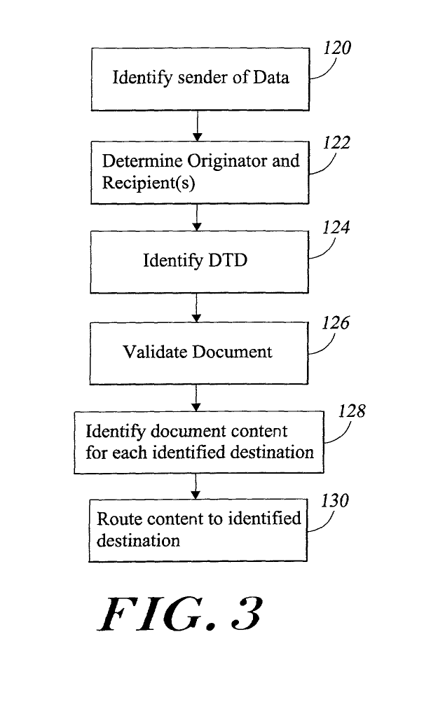

FIG. 3 is an illustrative flow chart that describes the interaction between the originator location 12, the directory 34 of the remote data access control facility 16 and the destination location 18. Once the originator location 12 packages the markup language document in a protocol that includes a markup language message header and a secure certificate, the originator location 12 forwards the markup language document, via the network 14, to the web server 32 of the remote data access control facility 16. When received at the web server 32, the transaction validation facility 36 identifies the originator of the markup language document (Step 120) by using the interface library 35 to search the directory 34 for the originator's public key object and any other identification objects contained in the originator's container class. Once the originator of the markup language document is identified, the transaction validation facility 36 determines from the markup language message header the document originator and the document recipient (Step 122).

At this point, the interface library 35, based on the identified originator and recipient, searches a library cache, a directory cache or other cache location for the necessary DTD object to validate the received markup language document (Step 124). Should the interface library 35 not find the required DTD object in any of the cache locations, the interface library 35 searches the directory 34 for the appropriate DTD object to validate the received markup language document. When the interface library 35 locates and retrieves the necessary DTD object, the interface library 35 presents the DTD object to a markup language parser that then validates the received markup language document (Step 126).

When the markup language parser has validated the received markup language document, the interface library 35 combines the originator and the recipient information provided in the document's message header with the business rule objects defined by the owner (the originator and the recipient) of the data in the directory 34 to determine the data content routing instructions (Step 128). The routing instruction identifies one or more destination location 18 and identifies which markup language content may be routed to an identified destination location 18. The business rule object may further segregate or define data content authorization for one or more specific users or group of users at the destination location 18. For example, a buyer may only view the purchase orders in the commodity class for which they have authorization to purchase, while the head of the purchasing department may have authorization to view all purchase orders

What is claimed is:

1. A method of managing data access in a communication network using a directory having one or more objects wherein the objects are organized in a hierarchical manner, the method comprising the steps of:
encapsulating data access information that defines content to be accessed into at least one of the objects in the directory;
encapsulating network user characteristics that define physical and logical characteristics of network users in at least one of the objects in the directory; and
enabling a user of the network to perform a data analysis on said data based on the data access information in at least one of the objects in the directory and based on the network characteristics in at least one of the objects in the directory.

2. The method of claim 1, further comprising the step of:
receiving documents in a markup language from one or more of the network users for storage on a data storage device; and
encapsulating data formulas that define how to interpret data content of the received markup language documents into at least one of the objects in the directory.

3. The method of claim 1, wherein there is a directory cache for caching information from the directory and wherein the method further comprises the step of:
storing at least some of the data access information in the directory cache.

4. The method of claim 2, wherein the markup language is the extensible Markup Language (XML).

5. The method of claim 2, wherein the data formulas includes a style sheet for defining a format for the performed data analysis.

6. The method of claim 2, wherein the data formulas includes a document type definition (DTD).

7. The method of claim 1, wherein the user characteristics includes the data analysis preferences defined by the network user.

8. The method of claim 2, wherein the received markup language documents indicates who may access the data.

9. The method of claim 1, wherein the data access information specifies who may access the data.

10. The method of claim 1, further comprising the step of:
providing a report generation facility object in the directory to generate reports.

11. The method of claim 1, wherein the network users characteristics
comprises one of an Internet Protocol (IP) address, a Uniform Resource Identifier (URI), a Domain Name System (DNS), and a digital certificate.

12. In a distributed network, a method for performing data analytics using a directory having one or more objects wherein said objects are organized in a hierarchical manner, the method comprising the steps of:
receiving one or more documents in a markup language for the data analysis;
providing at least one object that defines what the document should contain;
identifying an originator of the document and a recipient of the document from the document;
providing at least one object that defines how the document content is routed to other users of the distributed network based on the identified originator and the identified recipient;
providing user preferences that define the other users analytic report preferences;
selecting data required for the data analytics from the received data based on a selected other user access privileges; and
forwarding the selected data to the selected other user for use in the data analytics.

13. The method of claim 12, further comprising the step of, providing an analytic report format preference for the selected other user.

14. The method of claim 12, wherein the markup language is the extensible Markup Language (XML).

15. In a communication network, a method for controlling data distribution to selected users using a directory having one or more objects wherein the objects are organized in a hierarchical manner, the method comprising the steps of:
receiving at least one document in a markup language for distribution amongst one or more of the selected users;
identifying an originator and the selected users from the received document;
providing at least one object that defines how the document content is routed through the distributed network based on the identified originator and the selected users;
selecting the document content from the document that is available for the selected users; and
forwarding the selected document content to the selected users for data analytics.

16. The method of claim 15, wherein at least one of the objects in the directory defines the data format of the markup language document.

17. The method of claim 15, wherein at least one of the objects in the directory defines data content of the markup language document.

18. The method of claim 15, wherein at least one of the objects in the directory defines the s elected user's analytic report format.

19. In a communication network, a method for providing a directory having a plurality of objects and said objects being organized in a hierarchical manner for controlling access to data, comprising the steps of:
receiving data in a homogenous format from a plurality of network users for processing and storage;
identifying data content a selected user may access; and
forwarding the identified data to the selected user of the communication network.

20. An apparatus in a communication network having a directory to control data access and said directory having one or more objects, wherein the objects are organized in a hierarchical manner to control the data access in the communication network, said apparatus comprising:
a storage device to host said directory, wherein said directory includes at least one of the objects being an object class that contains one or more objects with one or more attributes that define data access information for a network user, and at least one of the objects being an object class that contains one or more objects with one or more attributes that define network user characteristics for the network user.

21. The apparatus of claim 20, wherein the data access information specifies which data the network user may access and a format for viewing the accessed data.

22. The apparatus of claim 20, wherein the user characteristics specifies physical and logical properties of the network users.

23. The apparatus of claim 20, further comprising an access mechanism that supports receipt of documents in a markup language from the network users.

24. The apparatus of claim 23, wherein the markup language is the extensible Markup Language (XML).

25. The apparatus of claim 20, further comprising a directory cache for caching information from the directory.

26. The apparatus of claim 23, further comprising at least one of the objects being an object class that contains one or more objects with one or more attributes that define one or more data formulas that define how to interpret the data in the received markup language documents.

27. The apparatus of claim 26, wherein the data formulas include style sheets and document type definitions.

28. The apparatus of claim 20, wherein the network user characteristics comprises one of an Internet Protocol (IP) address, a Uniform Resource Identifier (URI), a Domain Name System (DNS), and a digital certificate.

29. The apparatus of claim 20, further comprising a report generation facility object class in the directory to generate reports.

30. The apparatus of claim 20, wherein the network of user characteristics comprise the network user's data analysis preferences.

31. The apparatus of claim 23, wherein the access mechanism is an application programming interface.

32. In a distributed system, a directory having a plurality of objects, wherein said objects are organized in a hierarchical manner for managing data access within the distributed system, a computer readable medium holding computer executable instructions for performing a method, the method comprising the steps of:
encapsulating data access information that defines the data authorized for access in at least one of the objects in the directory;
encapsulating system user characteristics that define physical and logical characteristics of system users in at least one of the objects in the directory; and
enabling a user of the system to access the data based on the data access information and the system user characteristics to perform a data analysis on said data authorized for access.

33. The computer readable medium of claim 32, wherein there is a directory cache for caching information from the directory and wherein the method further comprises storing at least some of the data access information in the directory cache.

34. The computer readable medium of claim 32, further comprises the step of:
encapsulating data formulas that define how to interpret data content of documents received in a markup language into at least one of the objects in the directory.

35. The computer readable medium of claim 34, wherein the data formulas comprise document type definitions and style sheets.

36. The computer readable medium of claim 32, further comprising the steps of providing an access mechanism to receive the markup language documents from one or more of the system users for storage on a data storage device.
